(19) United States
(12) Patent Application Publication
(10) Pub. No.: US 2016/0358405 A1
(43) Pub. Date: Dec. 8, 2016

(54) DISPENSER PACKAGE FOR CUPS AND CUP LIDS

(71) Applicants: Olesya Izoita, West Springfield, MA (US); Aleksander I. Izoita, West Springfield, MA (US)

(72) Inventors: Olesya Izoita, West Springfield, MA (US); Aleksander I. Izoita, West Springfield, MA (US)

(21) Appl. No.: 14/606,143

(22) Filed: Jan. 27, 2015

(51) Int. Cl. G07F 11/30; G07F 9/10

(52) U.S. Cl. CPC G07F 11/30; G07F 9/10

(57) ABSTRACT

A dispenser package for cups and lids includes an enclosure, a cup chute is disposed within the enclosure for storing a plurality of cups, the cup chute defining an open end for dispensing the cups. A lid chute is disposed within the enclosure for storing a plurality of cup lids, the lid chute defining an open end for dispensing the cup lids. The container defining each of a cup opening adjacent the open end of the cup chute and a lid opening adjacent the open end of the lid chute for dispensing the cups and cup lids. In one embodiment, a straw compartment is disposed within the enclosure for storing a plurality of drinking straws, the container defining a straws opening for accessing the drinking straws.

### FIELD OF THE INVENTION

The present disclosure relates generally to a dispenser package for storing beverage cups and corresponding cup lids. More particularly, the disclosure relates to a dispenser package defining an enclosure having a first chute disposed within the container for storing a plurality of cups and a second chute disposed within the enclosure for storing a plurality of cup lids.

### BACKGROUND OF THE INVENTION

The statements in this section merely provide background information related to the present disclosure and may not constitute prior art.

Generally, various packaging and dispensing combinations for beverage cups and beverage lids are known in the art, including packaging combinations for both cups and matching lids in the same package. However, current packages often contain only a small number of matching quantities of cups and lids, e.g. ten or twelve sets of cups and lids.

Moreover, many packages for cups and lids are simply plastic bags, which are difficult for the user to store, less sanitary in use and do not function to dispense the product.

It is an object of the present teachings to provide a dispenser package for cups and cup lids that overcomes the shortcomings of prior art packaging.

### SUMMARY OF THE INVENTION

This section provides a general summary of the disclosure and does provide a comprehensive description or include full scope or all the features of the subject matter disclosed.

The present disclosure is directed to a dispenser package for storing cups and cup lids including a container defining an enclosure, a cup chute disposed within the enclosure for storing a plurality of cups, the cup chute defining an open end for dispensing the cups. A lid chute is disposed within the enclosure for storing a plurality of cup lids, the lid chute defining an open end for dispensing the cup lids, and the container defining each of a cup opening adjacent the open end of the cup chute and a lid opening adjacent the open end of the lid chute.

In one embodiment, the dispenser package includes a compartment disposed within the enclosure for storing a plurality of drinking straws, the container defining a straw opening for accessing the drinking straws.

In another embodiment, the dispenser package includes first, second and third covers for sealing and/or reclosing each of the cup opening, the lid opening and the straw opening, respectively.

In another embodiment, the dispenser package includes a cup chute disposed at an angle relative to a horizontal line disposed parallel to a plane of a bottom panel of the container, the angle being in a range of about zero degrees to about thirty degrees.

In another embodiment, the dispenser package according includes a lid chute disposed such that a length of the lid chute is positioned generally perpendicular to a plane of the bottom panel of the container.

Further areas of applicability will become apparent from the description provided herein, The description and specific examples in this summary are intended for purposes of illustration only and are not intended to limit the scope of the present disclosure.

### BRIEF DESCRIPTION OF THE DRAWINGS

The present teachings will become more fully understood from the detailed description, the appended claims and the following drawings. The drawings are for illustrative purposes only and are not intended to limit the scope of the present disclosure.

FIG. 1 is a perspective view of one embodiment of a dispenser package for cups and cup lids in accordance with the present invention.

FIG. 2 is a front side view of the dispenser package of FIG. 1.

FIG. 3 is a right side sectional view of the dispenser package of FIG. 1 taken at line A-A.

FIG. 4 is a partial perspective view of a cup opening according to another embodiment of the dispenser package of the present invention.

FIG. 5 is a partial perspective view of a lid opening according to another embodiment of the dispenser package of the present invention

FIG. 6 is a front side view of another embodiment of a dispenser package according to the present invention.

### DETAILED DESCRIPTION OF EMBODIMENTS OF THE INVENTION

Detailed illustrative descriptions of example embodiments are disclosed herein. However, specific structural and functional details disclosed herein are merely representative for purposes of describing example embodiments. The example embodiments may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the language explicitly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

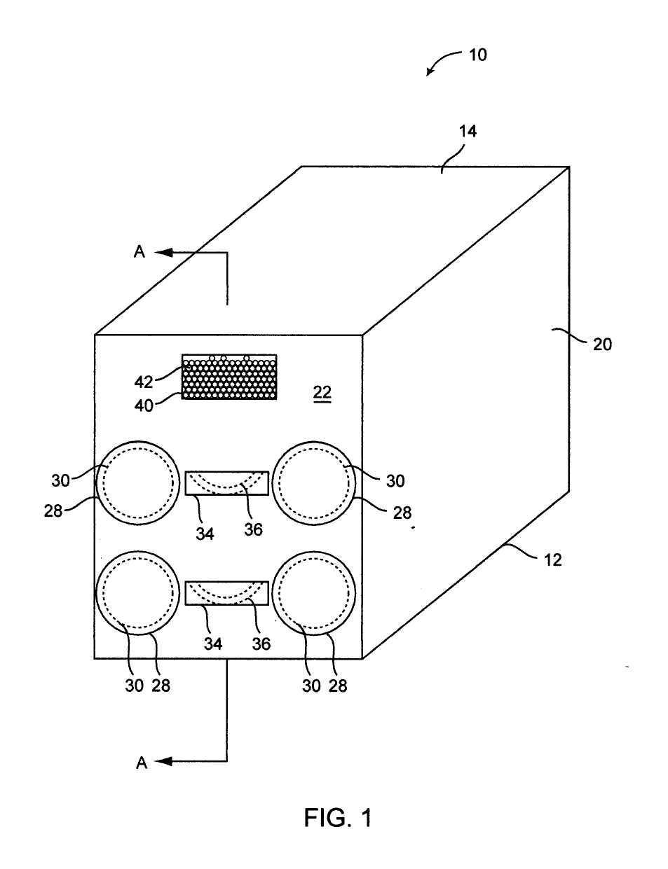

FIG. 1 illustrates an example embodiment of a dispenser package 10 for cups and cup lids according to the present invention. The dispenser package 10 includes an enclosure 12 (e.g., a box) defined by a top side 14, bottom side 16, left side 18, right side 20, front side 22, and rear side 24. The front side 22 defines a cup opening 28 from which cups 30 stored in the dispenser package 10 can be dispensed or accessed therethrough. In the FIG. 1 embodiment, there are four cup openings 28 defined by the front side 22 of the dispenser package 10. In other embodiments, the dispenser package 10 may include a different number of cup openings 28.

In one embodiment, the dispenser package 10 is made from paperboard or cardboard, however the dispenser package could be formed of plastic or other types of packaging materials known in the art.

Still referring to FIG. 1, the front side 22 of the enclosure 12 defines a lid opening 34 from which cup lids 36 stored in the dispenser package 10 can be dispensed or accessed therethrough. The dispenser package 10 includes two lid openings 34, however, in other embodiments, the dispenser package may include more or less than two lid openings 34.

The front side 22 also defines a straw opening 40 for accessing drinking straws 42 stored in the dispenser package 10. The drinking straws 42 may be sized for use with the cups 30 for drinking a beverage stored in a cup 30 through a drinking straw 42.

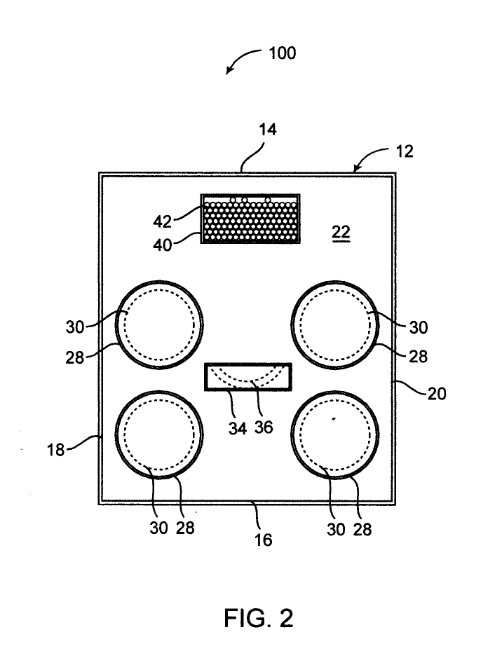

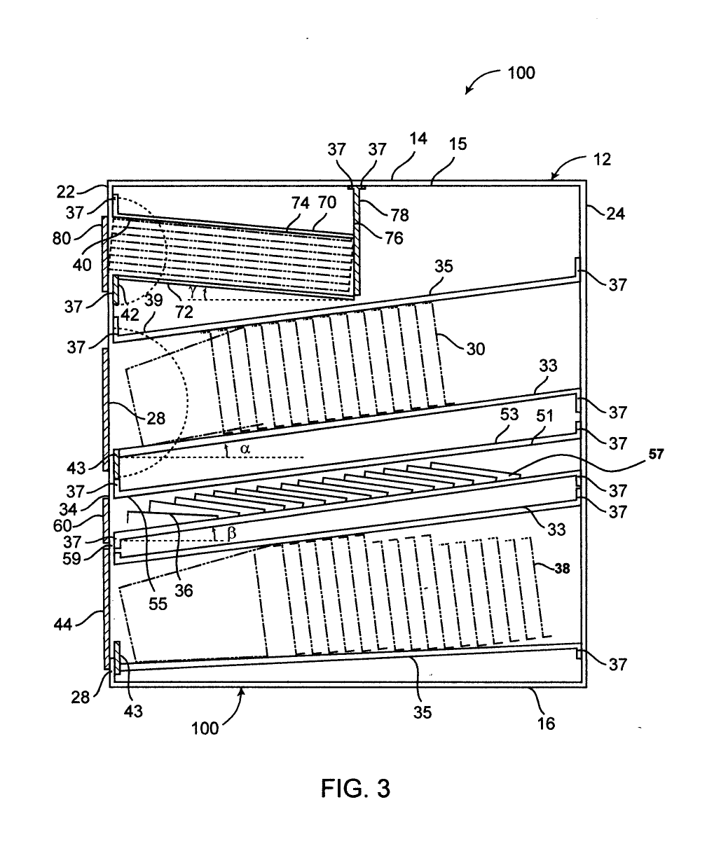

Referring to FIGS. 2 and 3, the dispenser package 100 is similar to the dispenser package 10 of FIG. 1 but includes only 1 lid opening 34. The dispenser package 100 includes first and second cup chutes 33 disposed interior the enclosure 12 for storing the cups 30 therein. The cup chutes 33 include a cup tube 35 disposed at an angle α relative to a horizontal line (disposed parallel to the plane of the bottom side 16 of the enclosure 12) and inclined away from the cup openings 28 towards the rear side 24. The angle α may be in a range between about zero degrees to about thirty degrees. In the FIG. 3 embodiment, the angle α is about 10 degrees above the horizontal.

A first end 39 of the cup tube 35 is attached to an inner side 23 of the front panel 22 of the enclosure 12 via a plurality of tabs 37. The tabs 37 extend outwardly from the ends of the cup tube 35. The cup opening 28 is substantially aligned with the first end 39 of the cup tube 35 for dispensing cups 30 from the cup tube 35 via the cup opening 28. A second end 41 of the cup tube 35 is attached to an inner side 25 of the rear panel 24 via a plurality of tabs 37 extending outwardly from the second end 41 of the cup tube 35. In one embodiment, the tabs 37 are attached to the mating surfaces of the enclosure via an adhesive, however, other types of fasteners may also be used, e.g., staples, welding, etc.

In the FIG. 3 embodiment, the cup chute 33 is generally linear, however, in other embodiments, the cup tube 35 can be arcuate or include one or more bends or curves for the purpose of extending a length of the cup chute 33 to accommodate a larger number of cups 30 compared to a straight cup chute 33. The cup tube 35 can have a cross section defining one of a square, circle, triangle, rectangle, oval, etc. for accommodating a plurality of cups 30. Typically, the cups are stored inside the cup tube 35 in a stacked configuration with each cup 30 inserted into the cup below it forming a stack 39 of cups 30 as shown in FIG. 3. The lowest cup 30 in the stack 39 is positioned adjacent the cup opening 28 to be the next cup to be dispensed or selected from the stack 39 and removed from the dispenser package 100 through the cup opening 28. A detent 43 is positioned at a lower edge of the first end 39 of the cup tube 35 and adjacent the inner side 23 of the front panel 22 for preventing the cups 30 from falling out of the enclosure 12 through the cup opening 28 prior to being removed from the stack 39 and the dispenser package 100.

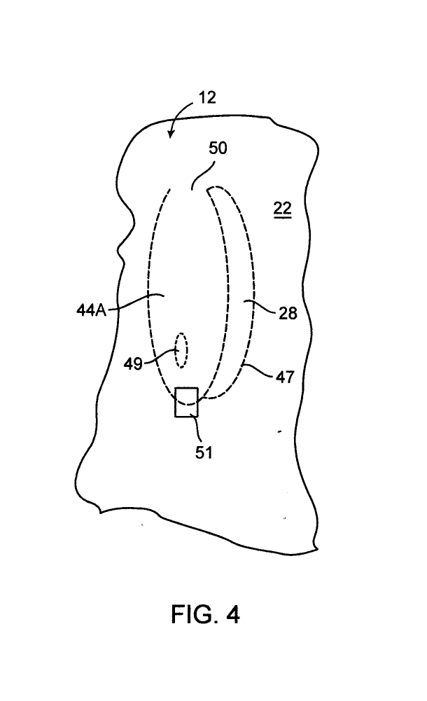

Still referring to FIG. 3, a cover 44 is affixed to the front side 22 of the enclosure 12 via an adhesive to close the cup opening 28 of the dispenser package 100. The cover 44 can be formed of paper or plastic (e.g., paperboard, sheet plastic, cellophane, etc.) and removably adhered to the front side 22 of the enclosure 12 to cover the cup opening 28. In one embodiment, the cover 44 can be configured to be removed and disposed wherein the cup opening 28 would remain open for accessing the cups 30 following removal of the cover 44. Alternatively, the cover 44 could be hingedly attached at one side of the cup opening 28 for resealing the cup opening after one or more cups 30 are removed from the cup opening as shown in FIG. 4.

FIG. 4 shows a cover 44A for the cup opening 28 formed from a section of the front side 22 of the enclosure 12 and partially separated from the enclosure via a perforation 47. The cover 44A is hingedly coupled to the dispenser package 100 via a hinge 50 defined by a non-perforated portion of the front side 22 of the dispenser package. The hinge 50 allowing movement of the cover 44A between open and closed positions relative to the cup opening 28. A cover tab 51 may be attached to the cover 44A for engagement with the inner side 23 of the front panel 22 for retaining the cover 44A in a closed position following an initial opening thereof. A perforated finger opening 49 may be provided for push out and use to grasp the cover 44A for opening and closing the cover with a finger of a user.

Referring again to FIG. 3, the dispenser package 100 includes a lid chute 51 disposed interior the enclosure 12 for storing the cup lids 36 therein. The lid chute 51 includes a lid tube 53 disposed at an angle β relative to a horizontal line (disposed parallel to the plane of the bottom panel 16 of the enclosure 12) and inclined away from the lid opening 34 towards the rear side 24. The angle β may be in a range between about zero degrees to about ninety degrees. In the FIG. 3 embodiment, the angle β is about 10 degrees above the horizontal.

A first end 55 of the lid tube 53 is attached to an inner side 23 of the front panel 22 of the enclosure 12 via a plurality of tabs 37. The tabs 37 extend outwardly from the ends of the lid tube 53. The lid opening 34 is substantially aligned with the first end 55 of the lid tube 53 for dispensing cup lids 36 from the lid tube 53 via the lid opening 34. A second end 56 of the lid tube 53 is attached to an inner side 25 of the rear panel 24 via a plurality of tabs 37 extending outwardly from the second end 56 of the lid tube 53. As set forth above with respect to the cup tube 35, in one embodiment, the tabs 37 are attached to the mating surfaces of the enclosure 12 via an adhesive, however, other types of fasteners may also be used, e.g., staples, welding, etc.

In the FIG. 3 embodiment, the lid chute 51 is generally linear, however, in other embodiments, the lid tube 53 can be arcuate or include one or more bends or curves for the purpose of extending a length of the lid chute 51 to accommodate a larger number of cup lids 36 compared to a straight lid chute 53. The lid tube 53 can have a cross section defining one of a square, circle, triangle, rectangle, oval, etc. for accommodating a plurality of cup lids 36. The FIG. 3 embodiment shows the cup lids 36 stored inside the lid tube 53 in a partially stacked configuration with each cup lid 36 being stacked on top of at least a portion of the cup lid below forming a row 57 of cup lids 36. The lowest cup lid 36 in the row 57 is positioned adjacent the lid opening 34 to be the next cup lid to be dispensed or selected from the row 57 and removed from the dispenser package 100 through the lid opening 34. A detent 59 is positioned at a lower edge of the first end 55 of the lid tube 53 and adjacent the inner side 23 of the front panel 22 for preventing the cup lids 36 from falling out of the enclosure 12 through the cup opening 34 prior to being removed from the row 57 and the dispenser package 100.

Still referring to FIG. 3, a cover 60 is affixed to the front side 22 of the enclosure 12 via an adhesive to close the lid opening 34 of the dispenser package 100. The cover 60 can be formed of paper or plastic (e.g., paperboard, sheet plastic, cellophane, etc.) and removably adhered to the front side 22 of the enclosure 12 to cover the lid opening 34. In one embodiment, the cover 60 can be configured to be removed and disposed wherein the lid opening 34 would remain open for accessing the cup lids 36 following removal of the cover 60. Alternatively, the cover 60 could be hingedly attached at one side of the lid opening 34 for resealing the lid opening after one or more cup lids 36 are removed from the lid opening as shown in FIG. 4.

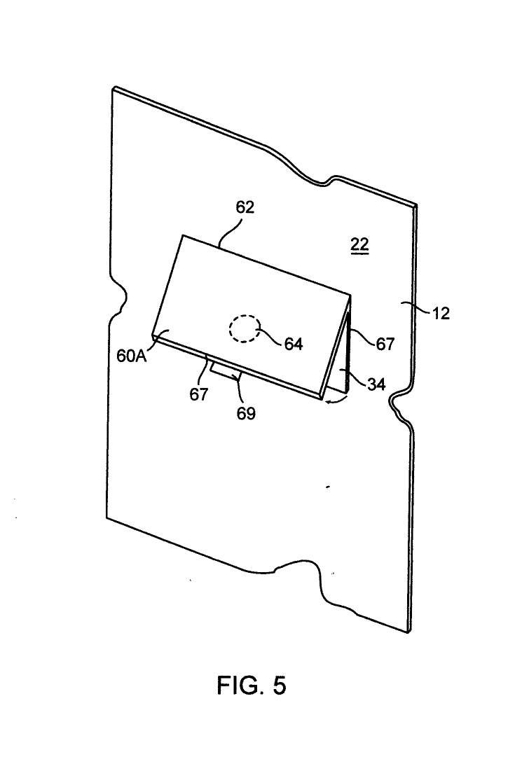

FIG. 5 shows a cover 60A for the lid opening 34 formed from a section of the front side 22 of the enclosure 12 and partially separated from the enclosure via a perforation 67. The cover 60A is hingedly coupled to the dispenser package 100 via a hinge 62 defined by a non-perforated portion of the front side 22 of the dispenser package. The hinge 62 allowing movement of the cover 60A between open and closed positions relative to the lid opening 34. A cover tab 69 may be attached to the cover 60A for engagement with the inner side 23 of the front panel 22 for retaining the cover 60A in a closed position following an initial opening thereof. A perforated finger opening 63 may be provided for push out and use to grasp the cover 60A for opening and closing the cover with a finger of a user.

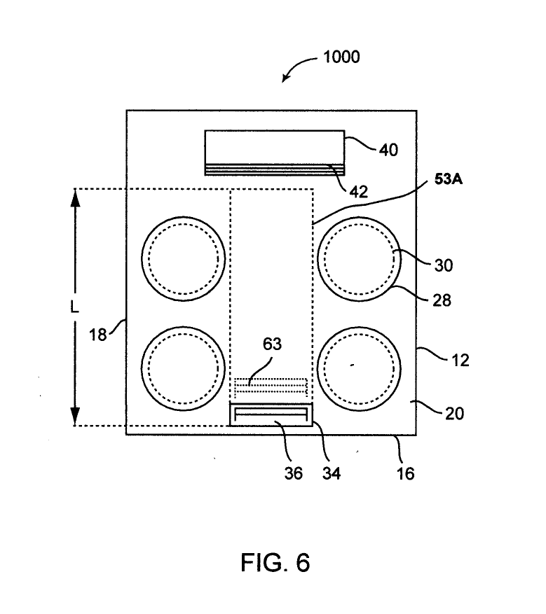

Referring now to FIG. 6, another embodiment of a dispenser package 1000 in accordance with the present invention includes a lid tube 53A having a length L disposed generally perpendicular to the plane of the bottom panel 16 of the enclosure 12. Although not shown, the angle β in this embodiment is approximately equal to 90 degrees measured from the horizontal plane of the bottom pane 16. A stack 63 of cup lids 36 are shown stored in the lid tube 53A. The stack 63 includes each cup lid 36 stacked one on top of the other. A bottom cup lid 36 in the stack is positioned adjacent the lid opening 34 for removal of the cup lid from the dispenser package by a user.

Referring again to FIG. 3, the dispenser package 100 includes a straw compartment 70 disposed interior the enclosure 12 for storing the drinking straws 42 therein. The straw compartment 70 includes a bottom wall 72, top wall 74 and rear wall 76, which together cooperate to form the compartment for storing drinking straws 42 therein. In the FIG. 3 embodiment the bottom wall 72 and parallel top wall 74 are disposed at an angle γ relative to a horizontal line (disposed parallel to the plane of the bottom panel 16 of the enclosure 12) and inclined downwardly away from the straw opening 40 so that the drinking straws 42 remain within the straw compartment 70. As shown in FIG. 3, the drinking straws are stored so that a length of the drinking straw is diposed generally perpendicular to the front panel 22 of the enclosure 12. A plurality of tabs 37 extend outwardly from a forward end of the top wall 74 and bottom wall 72 for securing the top and bottom walls (74, 72) to the inner side 23 as discussed hereinabove with respect to the cup chutes 33 and lid chute 51. A bracket 78 is attached to the rear wall 76 and an inner side 15 of the top panel 14 of the enclosure 12 for supporting the straw compartment 70 within the enclosure. As shown, the bracket 78 defines a plurality of tabs 37 for attaching the bracket 78 to the inner side 14 of the top panel 14 via an adhesive and/or as discussed herein with respect to the other components of the enclosure 12. The angle gamma, γ is in a range of about zero to about thirty degrees.

Still referring to FIG. 3, a cover 80 is affixed to the front side 22 of the enclosure 12 via an adhesive to close the straw opening 40 of the dispenser package 100. The cover 80 can be formed of paper or plastic (e.g., paperboard, sheet plastic, cellophane, etc.) and removably adhered to the front side 22 of the enclosure 12 to cover the straw opening 40. In one embodiment, the cover 80 can be configured to be removed and disposed wherein the straw opening 40 would remain open for accessing the drinking straws 42 following removal of the cover 80. Alternatively, the cover 80 could be hingedly attached at one side of the straw opening 40 for reclosing the straw opening after one or more drinking straws 42 are removed.

FIG. 6 shows a straw compartment 70A similar to the straw compartment 70 described above, yet configured to store the drinking straws 42 so that a length of the drinking straws are generally parallel to a plane of the front panel 22 of the enclosure 12. The straw opening 40 and cover 80 (not shown in FIG. 6) are generally the same as those described herein above with respect to FIG. 3.

One advantage of the dispenser package 10, 100, 1000 is that a user thereof can purchase and/or store a matched set of cups, lids and drinking straws that fit one another and cooperate to provide a convenient drinking cup with a lid and straw all in the same box. Thus, the user does not need to look at more than one shelf location in a store or at his/her home to find each of a cup, lid and straw for serving beverages therein.

Typically, the dispenser package 10, 100, 1000 is designed for use with beverage cups 30, cup lids 36 and drinking straws 42 made from one of paper or plastic materials, however, the dispenser package is not limited in this regard as other types of drinking cups, lids and straws could be stored within the dispenser package.

The dispenser package 10, 100 is configured to store the same number of cups 30, cup lids 36, and drinking straws 42. For example, in various embodiments, the dispenser package 10, 100, 1000 is configured to store approximately 24, 50, 80, 100, 120, 150, 200, or other amounts of cups, cup lids and drinking straws. The total number of cups and cup lids being arranged in equal numbers and divided between the cup chutes 33 and lid chutes 51 provided within the enclosure 12.

Example embodiments and methods thus being described, it will be appreciated by one skilled in the art that example embodiments and example methods may be varied through routine experimentation and without further inventive activity. For example, while the disclosure describes dispenser packages useable with cups and cup lids, and drinking straws variations of the disclosed embodiments may be used in connection with other configurations of packages described herein and achieve the same functions as disclosed herein. Variations are not to be regarded as departure from the spirit and scope of the exemplary embodiments, and all such modifications as would be obvious to one skilled in the art are intended to be included within the scope of the following claims.

What is claimed is:

1. A dispenser package for storing cups and cup lids comprising:
a container defining an enclosure;
a cup chute disposed within the enclosure for storing a plurality of cups, the cup chute defining an open end for dispensing the cups therethrough;
a lid chute disposed within the enclosure for storing a plurality of cup lids, the lid chute defining an open end for dispensing the cup lids therethrough; and
the container defining each of a cup opening adjacent the open end of the cup chute and a lid opening adjacent the open end of the lid chute.

2. The dispenser package according to claim 1 wherein the container further comprises a compartment disposed within the enclosure for storing a plurality of straws therein, the container defining a straws opening for accessing the straws therethrough.

3. The dispenser package according to claim 1 further comprising a first cover for sealing the cup opening.

4. The dispenser package according to claim 3 wherein the first cover is recloseable for sealing the cup opening following removing a cup from the cup chute.

5. The dispenser package according to claim 3 wherein the first cover further comprises a flap hingedly coupled to the container adjacent the cups opening for closing the cup opening.

6. The dispenser package according to claim 5 wherein the flap forms a reusable closure for the cup opening.

7. The dispenser package according to claim 1 further comprising a second cover for sealing the lid opening.

8. The dispenser package according to claim 7 wherein the second cover is reclosable.

9. The dispenser package according to claim 7 wherein the second cover further comprises a lid flap coupled to the container adjacent the lid opening for sealing the lid opening.

10. The dispenser package according to claim 9 wherein the lid flap forms a reusable closure for the lid opening.

11. The dispenser package according to claim 2 further comprising a third cover for sealing the straw opening.

12. The dispenser package according to claim 11 wherein the third cover is straws is reclosable.

13. The dispenser package according to claim 2 wherein the third cover further comprises a straw flap hingedly coupled to the container adjacent the straw opening for reclosing the straw opening.

14. The dispenser package according to claim 1 wherein the cup chute is disposed at an angle α relative to a horizontal line disposed parallel to a plane of a bottom panel of the container, the angle α being in a range of about zero degrees to about thirty degrees.

15. The dispenser package according to claim 1 wherein the lid chute is disposed at an angle β relative to a horizontal line disposed parallel to a plane of a bottom panel of the container, the angle β being in a range of about zero degrees to about thirty degrees.

16. The dispenser package according to claim 1 wherein the lid chute is disposed at an angle γ relative to a horizontal line disposed parallel to a plane of a bottom panel of the container, the angle γ being in a range of about zero degrees to about ninety degrees.

17. The dispenser package according to claim 1 wherein the lid chute is disposed so that a length of the lid chute is positioned generally perpendicular to a plane of the bottom panel of the container.

18. The dispenser package according to claim 2 wherein each of the cup chute, the lid chute and the straw compartment are each configured to store between about 25 and about 50 cups, cup lids, and drinking straws, respectively.

19. The dispenser package according to claim 2 wherein each of the cup chute, the lid chute and the straw compartment are each configured to store between about 50 and about 100 cups, cup lids, and drinking straws, respectively.

20. The dispenser package according to claim 1 wherein the container is configured to store approximately 100 cups, 100 cup lids and 100 drinking straws.
